(19) United States
(12) Patent Application Publication
(10) Pub. No.: US 2023/0090802 A1
(43) Pub. Date: Mar. 23, 2023

(54) LINK AGGREGATION GROUP (LAG) PORT SELECTION

(71) Applicant: Intel Corporation, Santa Clara, CA (US)

(72) Inventor: Martyn Ryan SHIRLEN, Raleigh, NC (US)

(21) Appl. No.: 18/072,110

(22) Filed: Nov. 30, 2022

(51) Int. Cl. H04L 45/16; H04L 47/41

(52) U.S. Cl. CPC H04L 45/16; H04L 47/41

(57) ABSTRACT

Examples described herein relate to switch circuitry to select a port of a link aggregation group (LAG) based on multiple tables and a multicast group identifier and hash value. In some examples, a first table of the multiple tables comprises indices for indexing into a second table of the multiple tables. In some examples, the second table comprises multiple LAG words to use to construct a LAG entry word.

### BACKGROUND

In networking, link aggregation seeks to bundle a number of Ethernet switch ports into a larger and/or wider bandwidth pipe. Network switches can implement a feature called Link Aggregation Group (LAG) per Institute of Electrical and Electronics Engineers (IEEE) specification 802.3ad (2017) governing LAG functionality. In addition to bandwidth aggregation, LAG also seeks to implement a resiliency property whereby ports belonging to a LAG bundle that are not live or accessible are removed from the LAG group and the remaining traffic bandwidth is distributed among the live and available ports within the LAG group.

Selection of ports that are bundled together into a LAG group can be controlled by host software. The most flexible LAG grouping solution possible would allow for any permutation of supported switch ports to be bundled into a group. For example, a switch with 512 ports would need to support bundling of all 2⁵¹² permutations of ports. However, providing this level of flexibility comes at a cost of increased logic gate area, power consumption, and combinatorial levels of logic/timing closure difficulty. In other words, as switch port radixes continues to increase, the hardware associated with this function is not scaling linearly with port radix.

### BRIEF DESCRIPTION OF THE DRAWINGS

FIGS. 1A and 1B depict an example system and normalization operations.

FIG. 2 depicts an of cost savings.

FIG. 3 depicts an example of LAG normalization.

FIG. 4 depicts an example system.

FIG. 5 depicts an example switch.

FIG. 6 depicts an example process.

### DETAILED DESCRIPTION

In some examples, to perform selection of a port of a LAG group to utilize to transmit packets of a flow, a switch multicast replication engine can receive an incoming multicast identifier (MCID) and hash (H2) value from a forwarding plane. The MCID value can be an identifier that uniquely delineates multicast streams from one another. The hash H2 can be generated by a hash generator engine in a forwarding pipe and an H2 function can be selected to attempt to evenly spread out bandwidth among port members of a LAG group of ports.

A known switch multicast replication engine can determine the output port for a given received packet according to operations (i) to (vii). At operation (i), a forwarding pipe sends a packet handle for a new packet subject to LAG replication to the Multicast Replication Engine (MRE). At operation (ii), according to the multicast identifier (MCID), the MRE looks up the root address for an L1L2 replication tree. The MRE then walks an L1L2 tree to LAG tree node(s).

At operation (iii), an index is used to look up an entry for a the LAG node in the LAG table within the MRE. For example, in a system supporting 576 total ports and 512 normal ports, the table is 512 entries x 576 bits per entry so that the 512 normal ports may belong to a unique LAG word within the table or LAG group. One or more of the bits of the LAG table word can denote a port within a LAG group. For example, bits of a LAG table word set to 1 indicate ports belonging to a given LAG group.

At operation (iv), after reading the LAG table, an adder tree adds bits in the LAG word (e.g., 576 bits) to form a length field, Len[9:0], and a sum of the set bits in the 576b vector. At operation (v), the incoming hash value, H2, is used to compute an outgoing port using the Len result (e.g., Selected Port=H2 modulo Len). The selected port result can be in a range [0 . . . Len-1]. At operation (vi), as the selected port is in the range [0 . . . Len-1], the selected port can be normalized to the original LAG ports (e.g., 130, 212, 505, and 525). For example, if the Selected Port=1, the Selected Port could be adjusted to correspond to port 212; Selected Port=3 could correspond to port 525, and so forth. Operation (vi) can utilize combinatorial logic which contributes both to utilization of silicon area but also to critical logic path depth and wiring congestion in a placed-and-routed design.

At operation (vii), a LAG table word takes two parallel computation paths to achieve an output packet handle per cycle. The computational paths can perform the same operations except a bottom path logically ANDs each bit of the LAG table word with the incoming 576 bit vector that indicates whether each bit of the LAG table word corresponds to a port that is live or not. For LAG to be resilient, if the top path LAG computation results in a port that is not live, then the bottom path provides a port that is live since prior to computation the ANDing with the live vector removes ports that are not live from the computation.

Known normalization logic can perform the following operations. Operation (a) can slice the incoming example 576b word into 8x 72b groups. Operation (b) can create series of sums that provide the sum of bits up to the first bit of each group. Operation (c) can create a series of sums that provide the sum of bits up to each bit within each group (not including other groups). Operation (d) can use the sums in operation (b) to determine the group number where the modulo result lands via a series of less than compares and compute the offset to the group the modulo landed in (e.g., bit position of first bit, e.g., group 1 offset is 72). Operation (e) can determine the bit position within group where the modulo lands in (d) using the sums from (c). Operation (f) can add the offset from operation (d) to the bit position from operation (e) to determine a final normalized port number result.

Determination of a live and available LAG port can incur at least several costs. Cost (A) can be related to LAG table scaling linearly in size/area with port radix of the switch. Cost (B) can be related to LAG normalization logic scaling nonlinearly in size/area with the port radix of the switch. For example, for N bits (ports) comprising a LAG table word, the total number of adders is (1 for 2^{nd} bit, 2 for 3^{rd} bit, 3 for 4^{th} bit, etc.):

$${\sum }_{i = 1}^{N} i = N ( N + 1 ) / 2$$

Accordingly, silicon area cost can be represented as a function of O(N²).

Some examples attempt to mitigate the costs of (A) and (B). At least to attempt to reduce memory utilization and circuitry utilized to select a port in a LAG group, a LAG port can be selected based on use of a LAG sum table and LAG table and a single adder and subtractor circuitry. For example, memory storage utilized for a LAG port selection for port radix number squared (e.g., 512×512 for 512 port system) can be reduced to use the of the two tables and arithmetic circuitry. A LAG sum table can store indexes and optionally store sum fields within a word. The LAG sum table can identify predetermined values in a LAG table and optionally include programmed sum values. The predetermined values from the LAG sum table can be used to construct an X bit word in this example, where X represents a number of ports (e.g., X=512 for a 512 port system). The LAG sum table can allow for deletion of ranks of adder trees implemented before a hash (modulo) operation, thus reducing LAG function logic gate cost. Use of the LAG table can allow for reducing a number of levels of logic, which can ease timing closure as well as place and route wiring congestion. For example, for a 512 port radix, instead of storing 2⁵⁷⁶ words, a subset of that space that can be used to store the LAG sum table. Even if the optional sum values are not implemented, a live bit correction can utilize one adder tree and 8×8 bit subtractors to replace the 8 adder trees that are instanced twice. By reducing area used to select a port in a LAG group in a multicast engine, other features can be added to a switch (e.g., port and queue support) due to reducing the area of an increasingly expensive function.

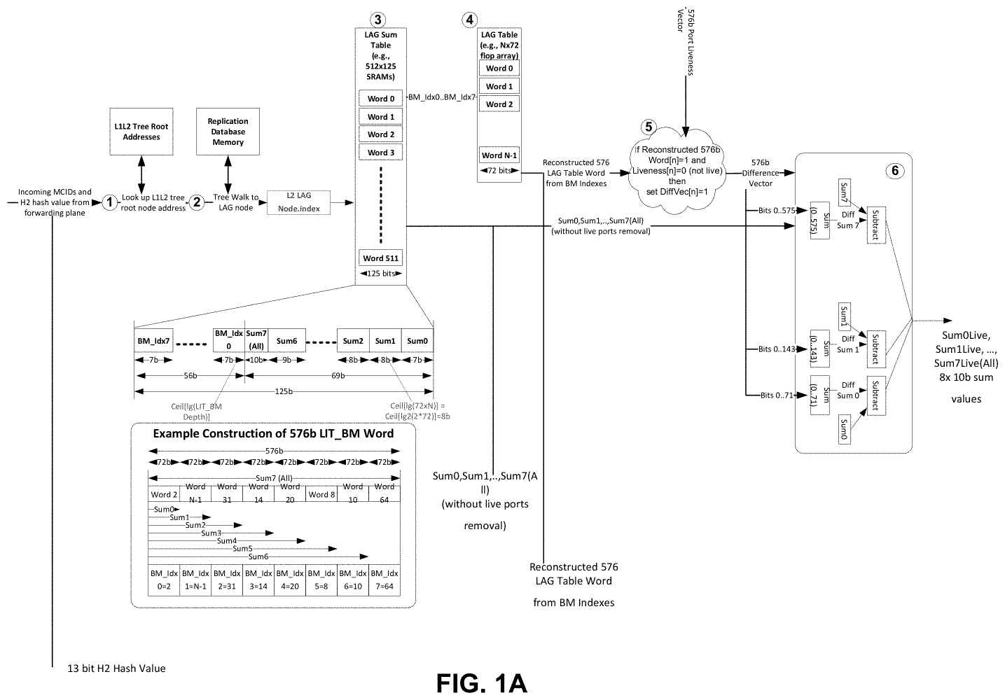

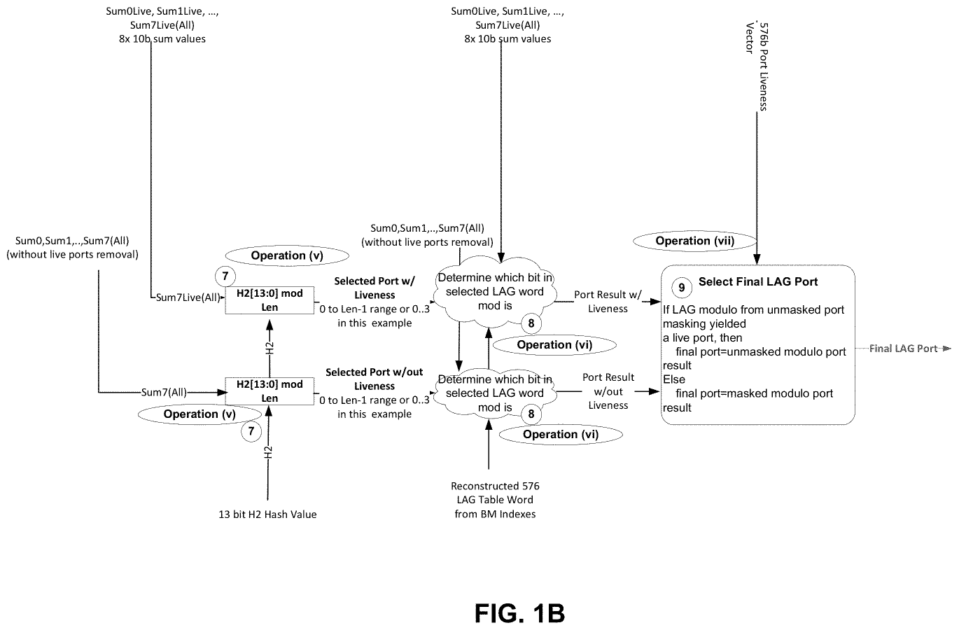

FIGS. 1A and 1B depict an example system that performs normalization operations. Normalization can perform operations (1) to (9). At (1), the incoming/selected word from the LAG table (e.g., 576b wide) can be summed to produce a Len field. At (2), the incoming 576b word can be sliced into 8 72b groups, where 8 sums can be created to represent how many bits were set up to the first bit of a given group: Sum(grp0), Sum(grp0,1), . . . , through Sum(grp0, 1, . . ,7). At (3), each of the eight slices has a SumUpToBit array created where the dimensions of the array are [71:0][6:0]. SumUpToBit_grp1[33][6:0] for group 1 can represent how many bits up to bit 33 including 33 are set in group 1 and does not include another group. At (4), the modulo result “Mod Result” can be computed.

In order to address the described cost (A) scaling issue above, the LAG table can be partitioned into multiple separate tables (e.g., LAG Sum Table and Lag Table) involved in operations (3) and (4). LAG Sum Table can hold a series of indices for indexing into Lag Table (e.g., BM_Idx0 . . . 7 in this example) as well as optional sum values (Sum0 . . . Sum7 in this example). A full 2⁵¹² space of possible values for a given LAG table word can be compressed into a LAG table which is smaller than 512 entries depth in this example in order to reduce area. For example, to build a 1000 bit vector but not expend 1000 bits of storage to describe that vector, the 1000 bit vector is divided into slices, e.g., 100 bits per slice. Hence, a bin of N 100 bit host programmed vectors can be stored that can be host-selected to form a 1000 bit vector. The smaller the bin, N, of blocks, the more area savings can be obtained.

The optional sum values can represent software precalculated sum values per operation (vi) described above. Since host software determines what ports to enable in a LAG group (LAG table word), host software (e.g., control plane) can compute the sums in operation (vi) which, if implemented, remove a rank of large/congestion contributing adder trees. Any set of sum values can be programmed by the host (e.g., sums from operations (b) and/or (c)).

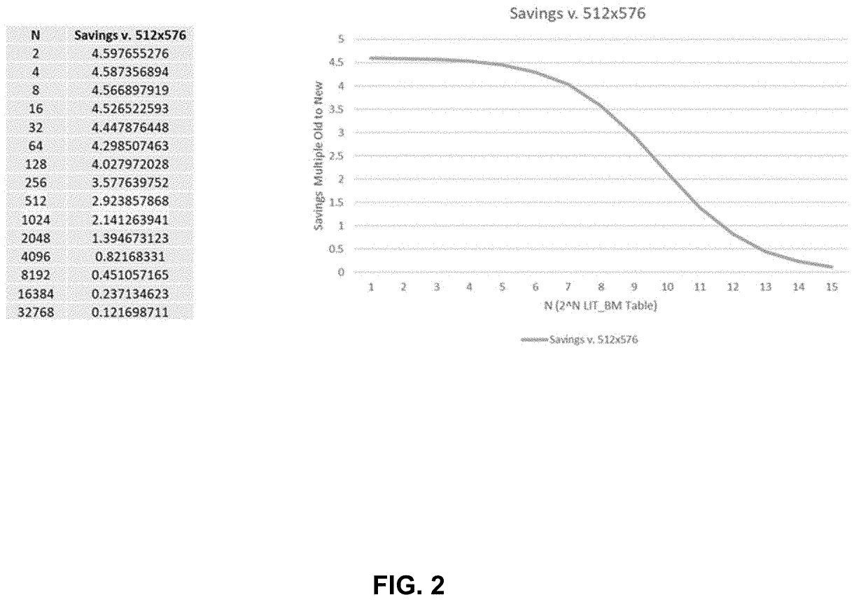

LAG Table can store a number of host programmed LAG words (e.g., 72b wide in this example) by which a user or control plane software or driver can select any permutation of these programmed 72b LAG words (e.g., 8 of them) to form the actual 576b LAG entry word. Choosing a depth of table that is much less than the original approach of 576 depth can yield a substantial decrease in silicon area utilization. Assuming N is the depth of the LAG Table, FIG. 2 depicts a table and graph shows the savings of use of an N depth LAG Table and LAG Sum Table. Note a group size can be 72b and there are 8 groups in the example 576b word. Other grouping size down to 1b or other sizes can be used. In the 1b width case, the sums from (c) above may not apply and the sums in (b) may apply.

Referring to FIG. 1A, operation (5) can calculate which group the modulo hit and the beginning bit offset of that group in the [0 . . . 575] range and create a mask of live ports in the reconstructed 576b LAG word to be used in operation (6). Operation (6) can calculate a 1-hot vector in the mod selected group corresponding to the FinalPort to create a series of adjusted sum values (SumGrp in the original approach) accounting for ports that are not live. Referring to FIG. 1B, operation (7) can encode the 1-hot vector into a binary value. Both the live masked and unmasked (Sum7(All) and Sum7Live(All)) values can be used as Len values in two parallel module calculations with hash value H2.

Operation (8) can encode the binary value back to the original LAG range by adding back in the group bit offset calculated in operation (6) (e.g., back in the 130, 212, 505, and 525 range). Operation (8) can be performed two times (e.g., two parallel operations) to resolve a live masked and unmasked port result. Operation (9) can determine if the live unmasked calculation in the operation (8) yielded a live port and if so the unmasked modulo port result becomes the final port result. Otherwise, the live masked port is the final port result.

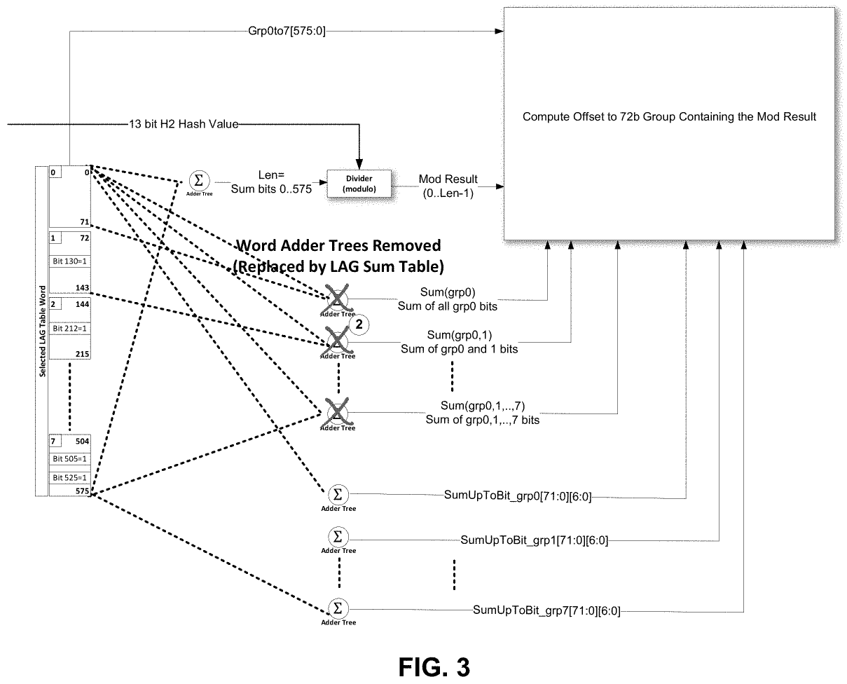

FIG. 3 depicts certain operations of a LAG normalization. Note that if the optional programmed LAG Sum Tables are utilized, a rank of adder trees (shown as X outs) can be removed from the design entirely and save silicon space. For example, use of adder trees in operation (2) can be removed.

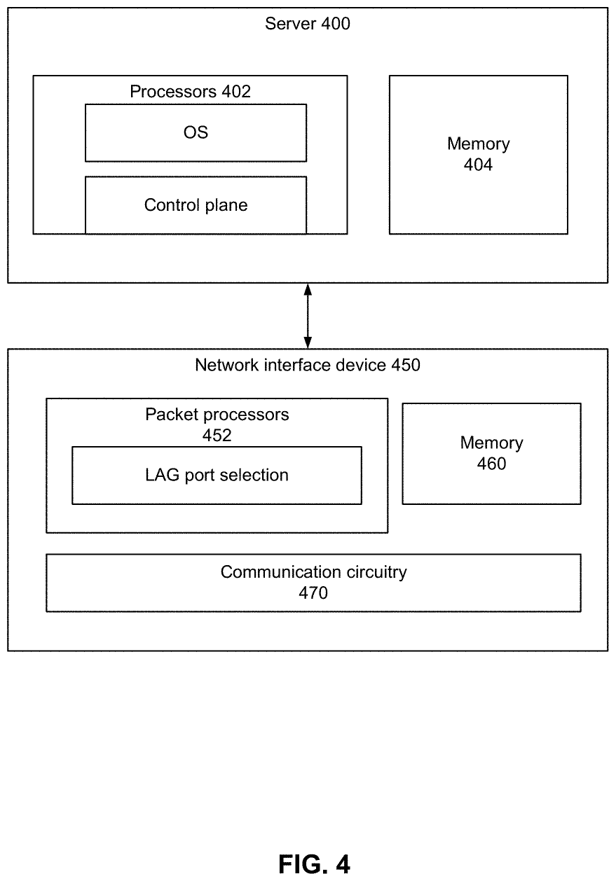

FIG. 4 depicts an example system. Server 400 can be coupled to network interface device 450 using a device interface or network connection, examples of which are described herein. Server 400 can include processors 402, memory 404, and other technologies described herein. In some examples, processors 402 can execute an operating system (OS) and control plane. OS can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

In some examples, a driver can configure network interface device 450 to perform port selection of a LAG group using circuitry and processes, described herein. In some examples, a driver can enable or disable offload to network interface device 450 from performing port selection of a LAG group. A driver can advertise capability of network interface device 450 to perform port selection of a LAG group.

Note that control plane can be implemented on server 400 or network interface device 450. Control plane can configure a number of host programmed LAG words in a LAG Table.

Network interface device 450 can be implemented as one or more of: network interface controller (NIC), SmartNlC, router, switch, forwarding element, infrastructure processing unit (IPU), or data processing unit (DPU). For example, communication circuitry 470 can include a physical layer interface (PHY), media access control (MAC) decoder and encoder circuitry, an Ethernet adapter, wireless interconnection components, cellular network interconnection components, or other wired or wireless standards-based or proprietary interfaces and processors.

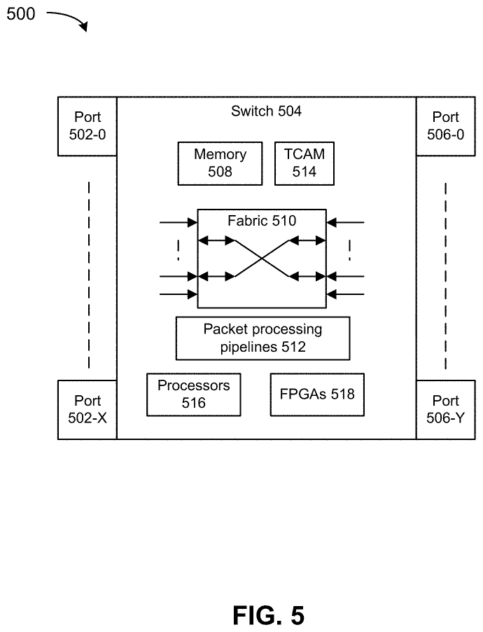

FIG. 5 depicts an example switch. Various examples can be used in or with the switch to select a port of a LAG group, as described herein. The switch can be implemented as a system on chip (SoC). Switch 504 can route packets or frames of any format or in accordance with any specification from any port 502-0 to 502-X to any of ports 506-0 to 506-Y (or vice versa). Any of ports 502-0 to 502-X can be connected to a network of one or more interconnected devices. Similarly, any of ports 506-0 to 506-Y can be connected to a network of one or more interconnected devices.

In some examples, switch fabric 510 can provide routing of packets from one or more ingress ports for processing prior to egress from switch 504. Switch fabric 510 can be implemented as one or more multi-hop topologies, where example topologies include torus, butterflies, buffered multi-stage, etc., or shared memory switch fabric (SMSF), among other implementations. SMSF can be any switch fabric connected to ingress ports and egress ports in the switch, where ingress subsystems write (store) packet segments into the fabric's memory, while the egress subsystems read (fetch) packet segments from the fabric's memory.

Memory 508 can be configured to store packets received at ports prior to egress from one or more ports. Packet processing pipelines 512 can determine which port to transfer packets or frames to using a table that maps packet characteristics with an associated output port. Packet processing pipelines 512 can be configured to perform match-action on received packets to identify packet processing rules and next hops using information stored in a ternary content-addressable memory (TCAM) tables or exact match tables in some examples. For example, match-action tables or circuitry can be used whereby a hash of a portion of a packet is used as an index to find an entry. Packet processing pipelines 512 can implement access control list (ACL) or packet drops due to queue overflow. Packet processing pipelines 512 can be configured to perform select a port of a LAG group, as described herein. Configuration of operation of packet processing pipelines 512, including its data plane, can be programmed using one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), x86 compatible executable binaries or other executable binaries, or others. Processors 516 and FPGAs 518 can be utilized for packet processing or modification.

Examples herein may be implemented in various types of computing, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other examples described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

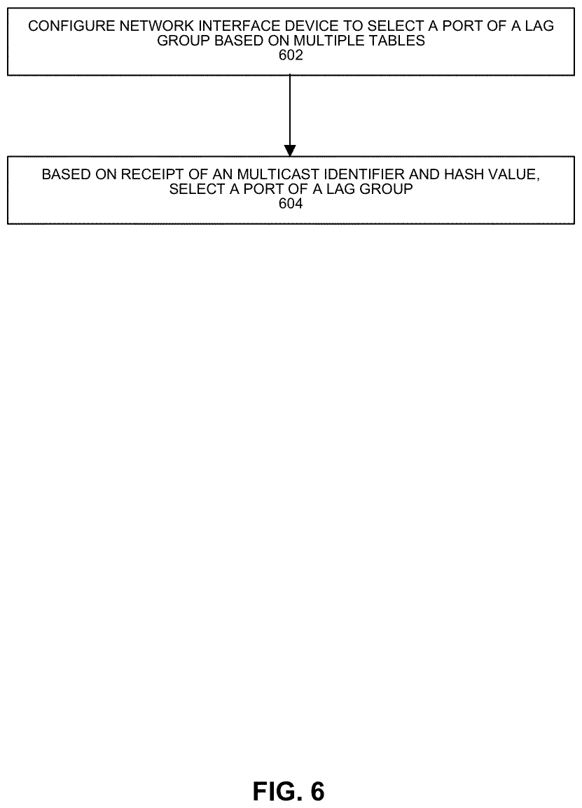

FIG. 6 depicts an example process. The process can be performed by a switch or other network interface device. At 602, a control plane can configure circuitry of a switch to select a port of a LAG group using a LAG sum table and LAG table. For example, adders that could otherwise be used to select a port of a LAG group can removed to free silicon space for other uses. For example, a LAG sum table can store indexes and optionally store sum fields within a word. For example, a LAG table can store a number of host programmed LAG words to form a LAG entry word. A LAG entry word can be used to determine live ports.

At 604, based on receipt of an MCID and H2 hash value, the switch can determine a live port of a LAG group using a LAG sum table and LAG table. For example, determination of a live port can be based on selection of one or more entries in a LAG table based on indices from a LAG sum table, constructing a LAG entry word based on the entries, and subtracting live ports from non-live ports. A port of a LAG group can be selected using multiple tables and an adder.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (APIs), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or examples. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in examples.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative examples. Furthermore, additional operations may be added or removed depending on the particular applications. Any combination of changes can be used and one of ordinary skill in the art with the benefit of this disclosure would understand the many variations, modifications, and alternative examples thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An example of the devices, systems, and methods may include any one or more, and any combination of, the examples described below.

What is claimed is:

1. An apparatus comprising:
a switch circuitry comprising:
circuitry, when operational, to:
based on receipt of a multicast group identifier and hash value, select a port of a link aggregation group (LAG) based on multiple tables and switch fabric circuitry, wherein:
a first table of the multiple tables comprises indices for indexing into a second table of the multiple tables and
the second table comprises multiple LAG words to use to construct a LAG entry word.

2. The apparatus of claim 1, wherein the first table of the multiple tables comprises pre-computed sum values.

3. The apparatus of claim 1, wherein the circuitry, when operational, is to: based on receipt of a multicast group identifier and hash value, select a port of the LAG based on multiple tables and a single adder.

4. The apparatus of claim 3, wherein one or more bits of the LAG entry word identify ports in the LAG.

5. The apparatus of claim 3, wherein one or more bits of the LAG entry word identify one or more ports that are part of a particular LAG group.

6. The apparatus of claim 3, wherein the circuitry, when operational, is to:
create difference vectors based on the LAG entry word and indicators of non-live ports and
adjust corresponding LAG sum table sum entries by subtraction of difference vector word slices of a reconstructed LAG word.

7. The apparatus of claim 1, comprising:
at least one ingress port coupled to the switch fabric circuitry and
at least one egress port coupled to the switch fabric circuitry.

8. The apparatus of claim 1, wherein LAG is consistent with Institute of Electrical and Electronics Engineers (IEEE) specification 802.3ad (2017).

9. The apparatus of claim 1, wherein the switch circuitry comprises one or more of: network interface controller (NIC), SmartNIC, router, forwarding element, infrastructure processing unit (IPU), or data processing unit (DPU).

10. A computer-readable medium comprising instructions stored thereon, that if executed by one or more processors, cause:
configuration of a network interface device to:
based on receipt of a multicast group identifier and hash value, select a port of a link aggregation group (LAG) based on contents of multiple tables and, when operational, utilization of a single adder.

11. The computer-readable medium of claim 10, wherein a first table of the multiple tables comprises indices for indexing into a second of the multiple tables.

12. The computer-readable medium of claim 10, wherein
a first table of the multiple tables comprises indices for indexing into a second table of the multiple tables and
the second table comprises multiple LAG words to use to construct a LAG entry word.

13. The computer-readable medium of claim 12, wherein one or more of bits of the LAG entry word identify ports in the LAG.

14. The computer-readable medium of claim 12, wherein one or more of bits of the LAG entry word identify zero or more live ports in the LAG.

15. The computer-readable medium of claim 10, wherein the network interface device comprises one or more of: switch circuitry, network interface controller (NIC), SmartNlC, router, forwarding element, infrastructure processing unit (IPU), or data processing unit (DPU).

16. A method comprising:
based on receipt of a multicast group identifier and hash value, selecting a port of a link aggregation group (LAG) based on access to multiple different tables and utilization of a single adder.

17. The method of claim 16, wherein a first table of the multiple different tables comprises indices for indexing into a second of the multiple tables.

18. The method of claim 16, wherein
a first table of the multiple different tables comprises indices for indexing into a second table of the multiple different tables and
the second table comprises multiple LAG words to use to construct a LAG entry word.

19. The method of claim 18, wherein one or more of bits of the LAG entry word identify ports in the LAG.

20. The method of claim 18, wherein one or more of bits of the LAG entry word identify zero or more live ports in the LAG.
